(19) United States
(12) Patent Application Publication
(10) Pub. No.: US 2018/0337567 A1
(43) Pub. Date: Nov. 22, 2018

(54) STATOR UNIT, MOTOR, AND FAN MOTOR

(71) Applicant: Nidec Corporation, Kyoto (JP)

(72) Inventors: Yuta YAMASAKI, Kyoto (JP); Hideki AOI, Kyoto (JP); Yoshihisa KITAMURA, Kyoto (JP); Shoki YAMAZAKI, Kyoto (JP); Yuki TSUKAMOTO, Kyoto (JP)

(21) Appl. No.: 15/984,454

(22) Filed: May 21, 2018

(30) Foreign Application Priority Data
May 22, 2017 (JP) 2017-100622
Oct. 31, 2017 (JP) 2017-211193

(51) Int. Cl. H02K 1/18; H02K 1/27; H02K 5/10; H02K 7/14; F04D 25/06

(52) U.S. Cl. CPC H02K 1/187; H02K 1/2786; F04D 25/06; H02K 7/14; H02K 5/10

(57) ABSTRACT

A fan motor includes an impeller that includes a plurality of vane portions rotatable about a central axis and a motor that rotates the impeller. The motor includes a rotor rotatable about the central axis and a stator unit that supports the rotor rotatable about the central axis. The stator unit includes a stator, a resin portion, and a fixing portion. The stator in which a conducting wire is wound around a stator core with an insulator interposed therebetween drives the rotor. The resin portion covers at least part of the stator. The fixing portion fixes the stator. The stator unit further includes a coating portion that covers at least one of an end portion of an interface between the stator and the resin portion and an end portion of an interface between the resin portion and the fixing portion.

### CROSS REFERENCE TO RELATED APPLICATIONS

This application claims the benefit of priority to Japanese Patent Application No. 2017-100622 filed on May 22, 2017 and Japanese Patent Application No. 2017-211193 filed on Oct. 31, 2017. The entire contents of these applications are hereby incorporated herein by reference.

### BACKGROUND OF THE INVENTION

### 1. Field of the Invention

The present disclosure relates to a stator unit, a motor, and a fan motor.

### 2. Description of the Related Art

There have been a variety of attempts to improve waterproof properties and dust proof properties of related-art motors. For example, the Japanese Laid-open Patent Application Publication 10-191611 discloses a brushless fan motor in which a stator is integrally molded with silicone rubber.

However, even when a stator unit is covered with resin as is the case with Japanese Laid-open Patent Application Publication 10-191611, water may arrive at the stator through an interface between the resin and a housing that accommodates the resin that covers the stator. Thus, a variety of adverse effects such as, for example, corrosion of a stator core and so forth may be caused.

In view of the above-described situation, an object of the present disclosure is to provide a stator unit, a motor, and a fan motor with which waterproof properties and dustproof properties can be improved.

### SUMMARY OF THE INVENTION

In order to achieve the above-described object, an exemplary stator unit of the present disclosure is to support a rotor rotatable about a central axis. The stator unit includes a stator, a resin portion, a fixing portion, and a coating portion. The stator includes a stator core, an insulator, and a conducting wire. The conducting wire is wound around the stator core with the insulator interposed between the stator core and the conducting wire. The resin portion covers at least part of the stator. The fixing portion fixes the stator. The coating portion covers at least one of an end portion of an interface between the stator and the resin portion and an end portion of an interface between the resin portion and the fixing portion.

Furthermore, in order to achieve the above-described object, an exemplary motor of the present disclosure includes the rotor and the above-described stator unit. The rotor is rotatable about the central axis. The stator unit includes the stator that drives the rotor.

Furthermore, in order to achieve the above-described object, an exemplary fan motor of the present disclosure includes an impeller and the above-described motor. The impeller includes a plurality of vane portions rotatable about the central axis. The motor rotates the impeller.

With the exemplary stator unit, the exemplary motor, and the exemplary fan motor of the present disclosure, the waterproof properties and the dustproof properties can be improved.

The above and other elements, features, steps, characteristics and advantages of the present disclosure will become more apparent from the following detailed description of the preferred embodiment with reference to the attached drawings.

### BRIEF DESCRIPTION OF THE DRAWINGS

FIG. 1 is a sectional view of an example of a fan motor.

FIG. 2 is a sectional view of an example of the structure of a coating portion according to an embodiment.

FIG. 3 is a sectional view of an example of the structure of the coating portion according to a first modification of the embodiment.

FIG. 4 is a sectional view of an example of the structure of the coating portion according to a second modification of the embodiment.

### DETAILED DESCRIPTION OF THE PREFERRED EMBODIMENTS

An exemplary embodiment of the present disclosure will be described below with reference to the drawings.

Herein, a direction parallel to a central axis CA is referred to as “axial direction” in a fan motor 100. Furthermore, a direction toward one side in the axial direction directed from a lid portion 23 toward a shaft holder 11, which will be described later, in the axial direction is referred to as “upper direction”. In contrast, a direction toward the other side in the axial direction directed from the shaft holder 11 toward the lid portion 23 in the axial direction is referred to as “lower direction”. Furthermore, regarding elements, an end portion of each of the elements in the axially lower direction is referred to as “lower end portion”, and an end portion of the element in the axially upper direction is referred to as “upper end portion”. Furthermore, out of surfaces of the elements, surfaces facing in the axially lower direction are referred to as “lower surfaces”, and surfaces facing in the axially upper direction are referred to as “upper surfaces”.

Furthermore, a direction that perpendicularly intersects the central axis CA is referred to as “radial direction”, and a circumferential direction centered at the central axis CA is referred to as “circumferential direction”. Furthermore, a direction directed toward the central axis CA in the radial direction is referred to as “inner direction”, and a direction directed so as to be separated from the central axis CA in the radial direction is referred to as “outer direction”. Furthermore, an end portion of each of the elements in the radially inner direction is referred to as “inner end portion”, and an end portion of the element in the radially outer direction is referred to as “outer end portion”. Furthermore, out of side surfaces of the elements, side surfaces facing in the radially inner direction are referred to as “inner side surfaces”, and side surfaces facing in the radially outer direction are referred to as “outer side surfaces”.

However, it should be understood that the designations such as directions, end portions, and surfaces described above do not represent the positional relationships, the directions, and so forth when actually assembled in an apparatus.

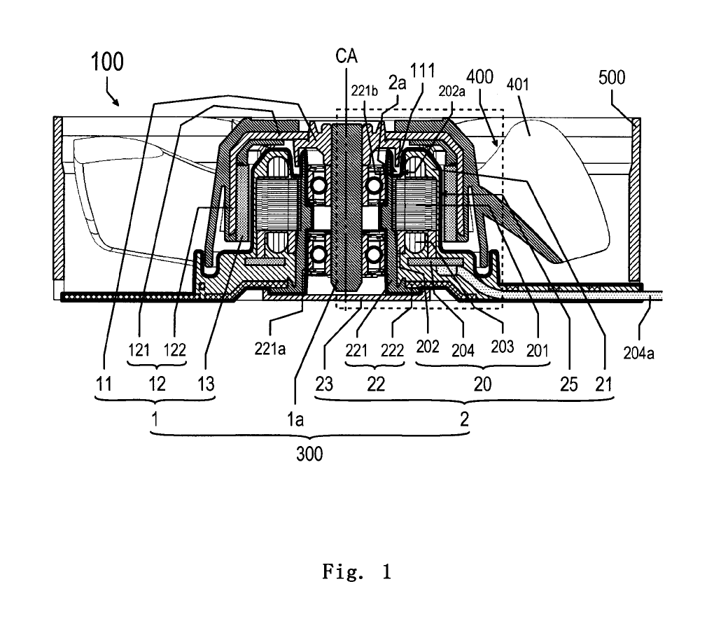

FIG. 1 is a sectional view of an example of the fan motor 100, illustrating a sectional structure of the fan motor 100 including the central axis CA.

As illustrated in FIG. 1, the fan motor 100 includes a motor 300 of an outer-rotor type, an impeller 400, and a casing 500. The motor 300 is a drive device that rotates the impeller 400. The impeller 400 is a vane wheel that includes a plurality of vane portions 401. The impeller 400 including the vane portions 401 is rotatable about the central axis CA. The impeller 400 is attached to an upper portion of the motor 300 in the axial direction. The impeller 400 is rotated about the central axis CA by the motor 300, thereby generating an airflow flowing in the axial direction. The casing 500 accommodates the motor 300 and the impeller 400.

Next, the structure of the motor 300 is described. As illustrated in FIG. 1, the motor 300 includes a rotor 1, a shaft 1a, and a stator unit 2.

The rotor 1 is rotatable relative to the stator unit 2 about the central axis CA extending in the upper-lower direction. The rotor 1 includes the shaft holder 11, a magnet support member 12, and a magnet 13. The shaft holder 11 is attached to the shaft 1a at an upper end portion of the motor 300 in the axially upper direction. The shaft holder 11 is provided with a projection 111 having an annular shape when seen in the axial direction. The projection 111 extends in the axially lower direction from the shaft holder 11. The projection 111 is not limited to the example illustrated in FIG. 1. The projection 111 may extend from the magnet support member 12. The magnet support member 12 holds the magnet 13. The magnet support member 12 includes a plate portion 121 and a cylindrical portion 122. The plate portion 121 having an annular shape extends in the radially outer direction from the shaft holder 11. The cylindrical portion 122 having a cylindrical shape extends at least in the axially lower direction from the outer end portion of the plate portion 121 in the radially outer direction. The magnet 13 is positioned further in the radially outer direction than a stator 20 of the stator unit 2, which will be described later. The magnet 13 is held by an inner side surface of the cylindrical portion 122 and faces an outer side surface of the stator 20.

The shaft 1a is a rotational shaft attached to the rotor 1, supports the rotor 1, and is rotatable together with the rotor 1 about the central axis CA. The shaft 1a is not limited to this example. The shaft 1a may be a fixed shaft attached to the stator unit 2. When the shaft 1a is a fixed shaft, a bearing (not illustrated) interposed between the rotor 1 and the shaft 1a is provided for the shaft 1a.

The stator unit 2 is a stationary portion held by the casing 500 and supports the rotor 1 rotatable about the central axis CA. The stator unit 2 includes the stator 20, a recess 2a, a resin portion 21, a fixing portion 22, the lid portion 23, and a coating portion 25. The stator unit 2 is fixed to the casing 500 by the fixing portion 22.

The stator 20 drives and rotates the rotor 1 when the motor 300 is driven. The stator 20 has an annular shape centered at the central axis CA and is fixed to a radially outer side of a support portion 221. The stator 20 includes a stator core 201, an insulator 202, a plurality of coil portions 203, and a substrate 204. The stator core 201 is an iron-core member that includes, for example, a laminated steel sheet in which electromagnetic steel sheets are laminated in the axial direction. The stator core 201 faces the magnet 13 of the rotor 1 in the radial direction. The insulator 202 is an insulating member formed of, for example, a resin material. The insulator 202 covers at least part of the stator core 201. In the stator 20, conducting wires are wound around the stator core 201 with the insulator 202 interposed therebetween, thereby the coil portions 203 are provided. The substrate 204 is electrically connected to the conducting wires of the coil portions 203 and connection 204a extending to the outside of the motor 300.

The recess 2a is provided between the insulator 202 and the support portion 221 at an upper end portion of the stator unit 2 in the axially upper direction. The recess 2a is recessed in the axially lower direction. The recess 2a has an annular shape when seen in the axial direction and accommodates at least part of the projection 111. Furthermore, the recess 2a together with the at least part of the projection 111 forms a labyrinth structure at the upper end portion of the stator unit 2 in the axially upper direction. The labyrinth structure can further increase the length of an entering path for moisture and dust from the radially outer side to an upper end portion of the support portion 221 in the axially upper direction. This reduces the likelihood of the moisture and the dust entering the upper end portion of the support portion 221.

The resin portion 21 covers at least part of the stator 20. Furthermore, according to the present embodiment, the resin portion 21 is positioned further in the radially outer direction than the recess 2a at the upper end portion of the stator unit 2 in the axially upper direction. This can further increase the width of the recess 2a in the radial direction. With the recess 2a increased in size, a space where the projection 111 is accommodated can be reliably obtained. Accordingly, the entering of the moisture and the dust can be more effectively suppressed. Furthermore, an upper end portion of the resin portion 21 in the axially upper direction is positioned further in the axially upper direction than an upper end portion of the insulator 202 in the axially upper direction. This further increases the length of the entering path for the moisture and the dust from the radially outer side to the upper end portion of the support portion 221 in the axially upper direction because the moisture and the dust additionally pass through a space between the projection 111 and the resin portion 21. This further reduces the likelihood of the moisture and the dust entering the upper end portion of the support portion 221.

The fixing portion 22 fixes the stator 20 to the casing 500. At least part of the fixing portion 22 is covered with the resin portion 21. The fixing portion 22 includes the support portion 221 and an attachment portion 222. That is, the stator unit 2 includes the support portion 221 and the attachment portion 222.

The support portion 221 having a cylindrical shape supports the stator 20. Bearings 221a are provided in the support portion 221, and further, the shaft 1a is inserted into the support portion 221. The shaft 1a is rotatably supported by the support portion 221 with the bearings 221a interposed therebetween. Although the bearings 221a are ball bearings according to the present embodiment, this example is not limiting. The bearings 221a may be, for example, sleeve bearings or the like.

The attachment portion 222 having an annular shape through which a plurality of through openings are formed is used to attach the stator unit 2 to the casing 500. More specifically, the stator 20 and the support portion 221 are attached to the casing 500, which accommodates the stator unit 2, by using the attachment portion 222. The support portion 221 is attached to an inner end portion of the attachment portion 222 in the radially inner direction. Furthermore, an outer end portion of the attachment portion 222 in the radially outer direction is attached to the casing 500. Furthermore, at least part of the attachment portion 222 is covered with the resin portion 21.

The lid portion 23 is fitted onto a lower end portion of the support portion 221 in the axially lower direction so as to cover the lower end portion.

The coating portion 25 is a coating film provided on a surface of the stator unit 2. Although it is not particularly limited, the thickness of the coating portion 25 is, for example, 25 μm. The coating portion 25 may be a dense evaporated film formed by, for example, vacuum deposition such as chemical vapor deposition (CVD). In this way, entering of water and dust into interfaces between the elements of the stator unit 2 can be more effectively suppressed or prevented. Alternatively, the coating portion 25 may be formed by, for example, dipping. Preferably, the coating portion 25 is a waterproof dense coating film. For example, a coating film formed of parylene (registered trademark), HumiSeal (registered trademark), Elepcoat (registered trademark), fluoropolymers, or the like may be used. However, the coating portion 25 is not limited to these.

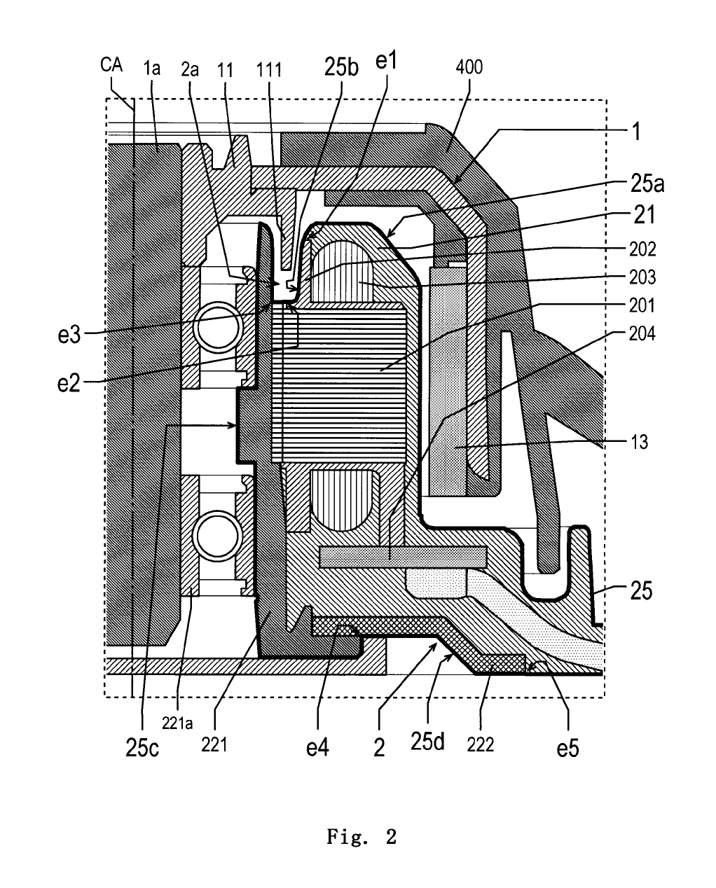

Next, an example of the structure of the coating portion 25 is described. FIG. 2 is a sectional view of the example of the structure of the coating portion 25 according to the embodiment. FIG. 2 corresponds to a portion of FIG. 1 surrounded by a broken line.

As illustrated in FIG. 2, according to the present embodiment, the coating portion 25 covers the entirety of the surface of the stator unit 2. In this way, entering of the water and the dust into the stator unit 2 disposed inside the coating portion 25 can be reliably suppressed or prevented. According to the present embodiment, a surface of the coating portion 25 is an outermost surface of the stator unit 2 and faces the outside of the stator unit 2.

More specifically, the coating portion 25 covers a first end portion e1 of an interface between the insulator 202 and the resin portion 21. In this way, entering of the water and the dust into the interface between the insulator 202 and the resin portion 21 through the first end portion e1 can be suppressed or prevented.

Furthermore, as illustrated in FIG. 2, according to the present embodiment, the resin portion 21 does not cover an inner surface of the recess 2a. Accordingly, the coating portion 25 directly covers the inner surface of the recess 2a and, in particular, covers a second end portion e2 of an interface between the stator core 201 and the insulator 202. In this way, entering of the water and the dust into the interface between the stator core 201 and the insulator 202 through the second end portion e2 can be suppressed or prevented. This can particularly suppress or prevent arriving of water at metal portions such as, for example, a stator core 201 and coil portions 203 through the interface between the stator core 201 and the insulator 202.

The coating portion 25 also covers a third end portion e3 of an interface between the stator core 201 and the support portion 221. In this way, entering of the water and the dust into the interface between the stator core 201 and the support portion 221 through the third end portion e3 can be suppressed or prevented.

The coating portion 25 also covers a fourth end portion e4 of an interface between the support portion 221 and the attachment portion 222. In this way, entering of the water and the dust into the interface between the support portion 221 and the attachment portion 222 through the fourth end portion e4 can be suppressed or prevented.

The coating portion 25 also covers a fifth end portion e5 of an interface between the resin portion 21 and the attachment portion 222. In this way, entering of the water and the dust into the interface between the resin portion 21 and the attachment portion 222 through the fifth end portion e5 can be suppressed or prevented.

Furthermore, as illustrated in FIG. 2, according to the present embodiment, the coating portion 25 includes first to fourth coating portions 25a to 25d. However, the coating portion 25 is not limited to the example illustrated in FIG. 2. The coating portion 25 may include at least one of the first to fourth coating portions 25a to 25d.

The first coating portion 25a directly covers a surface of the resin portion 21. In this way, a surface of the first coating portion 25a covering the resin portion 21 serves as part of the surface of the stator unit 2. Accordingly, this part of the surface of the stator unit 2 becomes smooth by being covered with the first coating portion 25a, which is dense, even when the surface of the resin portion 21 is not very smooth. Accordingly, adhering of the dust to this part of the surface of the stator unit 2 can be suppressed. Furthermore, contact of the water with the resin portion 21 can be suppressed or prevented. Furthermore, when the first coating portion 25a has water repellency, adhering of the water to the surface of the first coating portion 25a can be suppressed. This can suppress or prevent degradation of the resin portion 21. Furthermore, the distance required for the water and the dust to arrive at the metal portions such as a stator core 201 and coil portions 203 from, for example, the outside of the stator unit 2 can be further increased. Accordingly, waterproof properties and dustproof properties of the stator unit 2 can be further improved.

The second coating portion 25b directly covers a surface of the insulator 202. In this way, a surface of the second coating portion 25b covering the insulator 202 serves as part of the surface of the stator unit 2. Accordingly, this part of the surface of the stator unit 2 becomes smooth by being covered with the second coating portion 25b, which is dense, even when the surface of the insulator 202 is not very smooth. Accordingly, adhering of the dust to this part of the surface of the stator unit 2 can be suppressed. Furthermore, contact of the water with the insulator 202 can be suppressed or prevented. Furthermore, when the second coating portion 25b has water repellency, adhering of the water to the surface of the second coating portion 25b can be suppressed. Furthermore, the distance required for the water and the dust to arrive at the metal portions such as a stator core 201 and coil portions 203 from, for example, the outside of the stator unit 2 can be further increased. Accordingly, the waterproof properties and the dustproof properties of the stator unit 2 can be further improved.

The third coating portion 25c directly covers a surface of the support portion 221. In this way, a surface of the third coating portion 25c covering the support portion 221 serves as part of the surface of the stator unit 2. Accordingly, this part of the surface of the stator unit 2 becomes smooth by being covered with the third coating portion 25c, which is dense, even when the surface of the support portion 221 is not very smooth. Accordingly, adhering of the dust to this part of the surface of the stator unit 2 can be suppressed. Furthermore, contact of the water with the support portion 221 can be suppressed or prevented. Furthermore, when the third coating portion 25c has water repellency, adhering of the water to the surface of the third coating portion 25c can be suppressed. Furthermore, the distance required for the water and the dust to arrive at the metal portions such as a stator core 201 and coil portions 203 from, for example, the outside of the stator unit 2 can be further increased. Accordingly, the waterproof properties and the dustproof properties of the stator unit 2 can be further improved.

The fourth coating portion 25d directly covers a surface of the attachment portion 222. In this way, a surface of the fourth coating portion 25d covering the attachment portion 222 serves as part of the surface of the stator unit 2. Accordingly, this part of the surface of the stator unit 2 becomes smooth by being covered with the fourth coating portion 25d, which is dense, even when the surface of the attachment portion 222 is not very smooth. Accordingly, adhering of the dust to this part of the surface of the stator unit 2 can be suppressed. Furthermore, contact of the water with the attachment portion 222 can be suppressed or prevented. Furthermore, when the fourth coating portion 25d has water repellency, adhering of the water to this surface can be suppressed. This can suppress or prevent degradation (for example, corrosion) of the attachment portion 222. Furthermore, the distance required for the water and the dust to arrive at the metal portions such as a stator core 201 and coil portions 203 from, for example, the outside of the stator unit 2 can be further increased. Accordingly, the waterproof properties and the dustproof properties of the stator unit 2 can be further improved.

As illustrated in FIG. 2, according to the present embodiment, the coating portion 25 covers the surface of the stator unit 2 including the first to fifth end portions e1 to e5, and the coating portion 25 includes the first to fourth coating portions 25a to 25d. However, the coating portion 25 is not limited to the example illustrated in FIG. 2. The coating portion 25 may cover at least one of the end portion of the interface between the stator 20 and the resin portion 21 and the end portion of the interface between the resin portion 21 and the fixing portion 22. In this way, entering of the water and the dust into either or both of the interface between the stator 20 and the resin portion 21 through the end portion of this interface and the interface between the resin portion 21 and the fixing portion 22 through the end portion of this interface can be suppressed or prevented. Accordingly, the waterproof properties and the dustproof properties of the stator unit 2 can be improved. In particular, arriving of water at the metal portions such as a stator core 201 and coil portions 203 through either or both of the end portion of the interface between the stator 20 and the resin portion 21 and the interface between the resin portion 21 and the fixing portion 22 can be suppressed or prevented. Thus, corrosion of the metal portions can be suppressed or prevented.

Furthermore, it is sufficient that the coating portion 25 cover at least one of at least the first end portion e1, the third end portion e3, and the fifth end portion e5.

More specifically, the coating portion 25 may cover at least the first end portion e1 of the interface between the insulator 202 and the resin portion 21. In this way, at least entering of the water and the dust through the first end portion e1 into the interface between the insulator 202 and the resin portion 21 can be suppressed or prevented. This can particularly suppress or prevent arriving of the water at the metal portions such as, for example, a stator core 201 and coil portions 203 through the interface between the insulator 202 and the resin portion 21.

Alternatively, the coating portion 25 may cover at least the third end portion e3 of the interface between the stator core 201 and the support portion 221. In this way, at least entering of the water and the dust into the interface between the stator core 201 and the support portion 221 through the third end portion e3 can be suppressed or prevented. This can particularly suppress or prevent arriving of the water at the metal portions such as, for example, a stator core 201 and coil portions 203 through the interface between the stator core 201 and the support portion 221.

Alternatively, the coating portion 25 may cover at least the fifth end portion e5 of the interface between the resin portion 21 and the attachment portion 222. In this way, at least entering of the water and the dust into the interface between the resin portion 21 and the attachment portion 222 through the fifth end portion e5 can be suppressed or prevented. This can particularly suppress or prevent arriving of the water at the metal portions such as, for example, a stator core 201 and coil portions 203 through the interface between the resin portion 21 and the attachment portion 222.

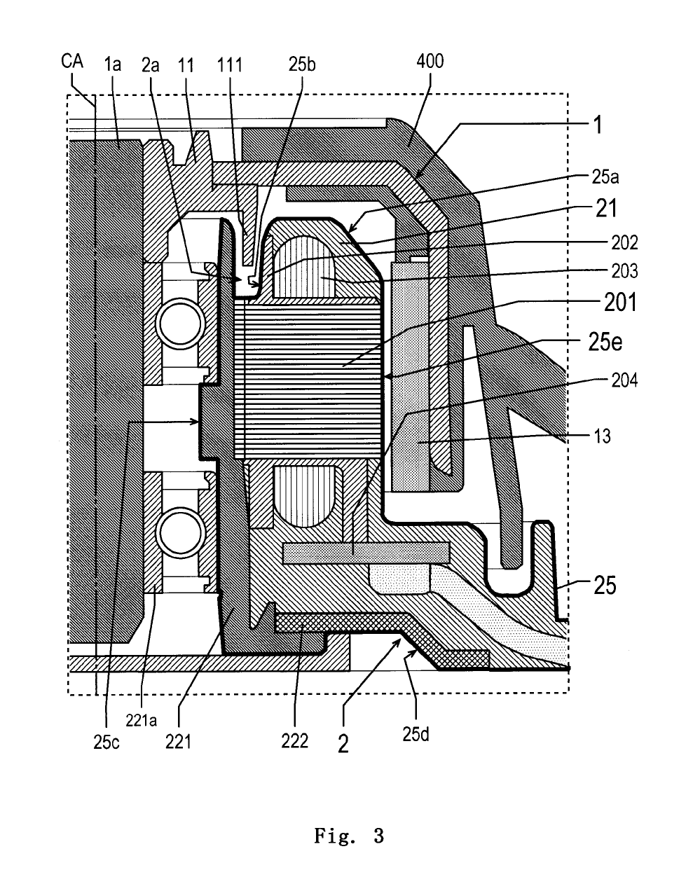

Next, a first modification of the embodiment is described. FIG. 3 is a sectional view of an example of the structure of the coating portion according to the first modification of the embodiment. FIG. 3 corresponds to, for example, the portion of FIG. 1 surrounded by a broken line.

As illustrated in FIG. 3, according to the first modification, an outer side surface of the stator core 201 in the radial direction is not covered by the resin portion 21. In the radial direction, the outer side surface of the stator core 201 is located at the same position as or further to the outer side than the outer end portion of the insulator 202.

Furthermore, the coating portion 25 includes a fifth coating portion 25e. The fifth coating portion 25e directly covers the surface of the stator core 201 facing the magnet 13.

In this way, even when the resin portion 21 is not provided on the surface of the stator core 201 facing the magnet 13, contact of the water and the dust with this surface can be suppressed or prevented by the fifth coating portion 25e. Furthermore, when the fifth coating portion 25e has water repellency, adhering of the water to this surface can be suppressed. This can suppress or prevent degradation (for example, corrosion) of the stator core 201. Furthermore, this can prevent coating defects (so-called “short shots”) of the resin portion that are likely to occur on the surface of the stator core 201 facing the magnet 13 during formation of the resin portion 21 on the stator unit 2.

Furthermore, compared to the case where the outer side surface of the stator core 201 is covered by the resin portion 21, either or both of the following can be realized: the outer diameter of the stator core 201 is increased; and an inner end portion of the magnet 13 in the radially inner direction is located further in the radially inner direction. Accordingly, a gap between the stator core 201 and the magnet 13 of the rotor 1 attached to the stator unit 2 can be reduced. This facilitates rotation of the rotor 1 due to drive of the stator 20, thereby allowing drive efficiency of the motor 300 to be improved.

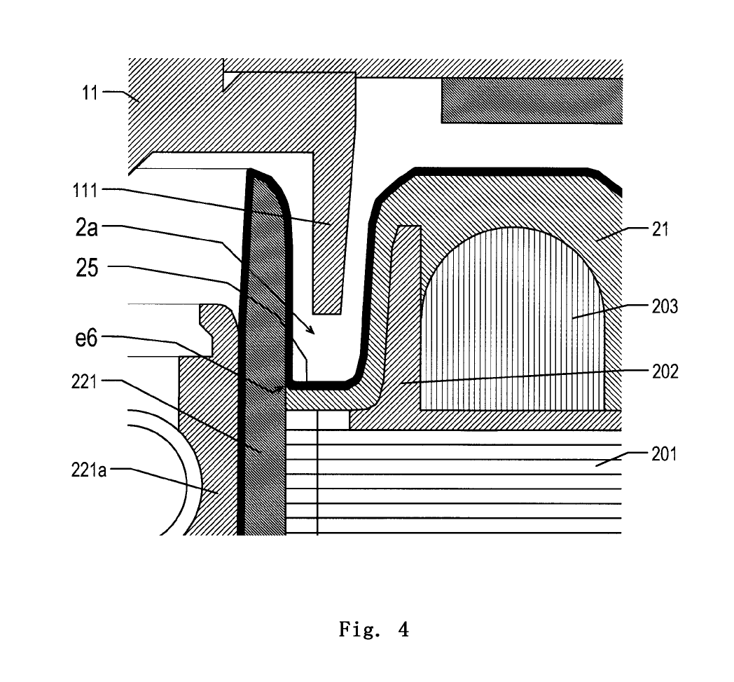

Next, a second modification of the embodiment is described. FIG. 4 is a sectional view of an example of the structure of the coating portion 25 according to the second modification of the embodiment, illustrating a sectional structure of the recess 2a and a region near the recess 2a of the fan motor 100 according to the second modification when seen in the radial direction.

According to the second modification, as illustrated in FIG. 4, the resin portion 21 is also provided in the recess 2a and in contact with the support portion 221 at the upper end portion of the stator unit 2 in the axially upper direction. Furthermore, the coating portion 25 also covers a sixth end portion e6 of the interface between the support portion 221 and the resin portion 21. In this way, in the recess 2a, entering of the water and the dust into the interface between the support portion 221 and the resin portion 21 through the sixth end portion e6 can be suppressed or prevented. This can particularly suppress or prevent arriving of the water at the metal portions such as, for example, a stator core 201 and coil portions 203 through the interface between the support portion 221 and the resin portion 21.

The embodiment according to the present disclosure has been described. The scope of the present disclosure is not limited to the above-described embodiment. The present disclosure can be carried out by making a variety of changes without departing from the gist of the invention. Features of the above-described preferred embodiment may be combined appropriately as long as no conflict arises.

For example, although the fan motor 100 is an axial flow fan according to the above-described embodiment, this is not limiting. The fan motor 100 may be a centrifugal fan. That is, the fan motor 100 may generate an airflow flowing to the outside in the radial direction.

For example, although the motor 300 is of the outer-rotor type (see FIG. 1) according to the above-described embodiment and the modifications of the embodiment, this is not limiting. The motor 300 may be of an inner-rotor type. When the motor 300 is of the inner-rotor type, the magnet 13 of the rotor 1 is located further in the radially inner direction than the stator 20.

The present disclosure is useful for, for example, a motor or the like that includes a stator unit in which the stator is covered by a resin portion.

Features of the above-described preferred embodiment and the modifications thereof may be combined appropriately as long as no conflict arises.

While a preferred embodiment of the present invention has been described above, it is to be understood that variations and modifications will be apparent to those skilled in the art without departing from the scope and spirit of the present invention. The scope of the present invention, therefore, is to be determined solely by the following claims.

What is claimed is:

1. A stator unit that is to support a rotor rotatable about a central axis, the stator unit comprising:
a stator that includes
a stator core,
an insulator, and
a conducting wire wound around the stator core with the insulator interposed between the stator core and the conducting wire;
a resin portion that covers at least part of the stator;
a fixing portion that fixes the stator; and
a coating portion that covers at least one of an end portion of an interface between the stator and the resin portion and an end portion of an interface between the resin portion and the fixing portion.

2. The stator unit according to claim 1,
wherein the coating portion is an evaporated film.

3. The stator unit according to claim 1,
wherein the coating portion at least covers a first end portion of an interface between the insulator and the resin portion.

4. The stator unit according to claim 1,
wherein the coating portion further covers a second end portion of an interface between the insulator and the stator core.

5. The stator unit according to claim 1,
wherein the coating portion includes a first coating portion that directly covers a surface of the resin portion.

6. The stator unit according to claim 1,
wherein the coating portion includes a second coating portion that directly covers a surface of the insulator.

7. The stator unit according to claim 1,
wherein the fixing portion includes a support portion that supports the stator, and
wherein the coating portion at least covers a third end portion of an interface between the stator core and the support portion.

8. The stator unit according to claim 7,
wherein the coating portion includes a third coating portion that directly covers a surface of the support portion.

9. The stator unit according to claim 7,
wherein the fixing portion further includes an attachment portion with which the support portion is attached to a casing that accommodates the stator unit, and
wherein the coating portion further covers a fourth end portion of an interface between the support portion and the attachment portion.

10. The stator unit according to claim 9,
wherein the resin portion further covers at least part of the attachment portion, and
wherein the coating portion at least covers a fifth end portion of an interface between the resin portion and the attachment portion.

11. The stator unit according to claim 9,
wherein the coating portion includes a fourth coating portion that directly covers a surface of the attachment portion.

12. The stator unit according to claim 1,
wherein the stator core is to face a magnet of the rotor, and
wherein the coating portion includes a fifth coating portion that directly covers a surface of the stator core that is to face the magnet.

13. The stator unit according to claim 1,
wherein the fixing portion includes a support portion,
wherein, at an end portion of the stator unit on one side in an axial direction, the resin portion is in contact with the support portion, and the coating portion covers a sixth end portion of an interface between the support portion and the resin portion.

14. The stator unit according to claim 1,
wherein the coating portion covers an entirety of a surface of the stator unit.

15. A motor comprising:
a rotor rotatable about a central axis; and
the stator unit according to claim 1 that includes the stator that drives the rotor.

16. A fan motor comprising:
an impeller that includes a plurality of vane portions rotatable about a central axis; and
the motor according to claim 15 that rotates the impeller.
